(19) United States
(12) Patent Application Publication
(10) Pub. No.: US 2010/0080007 A1
(43) Pub. Date: Apr. 1, 2010

(54) Light distribution board having improved grating structure including a plurality of light gratings each with multiple focuses

(76) Inventor: Ping-Han Chuang, Taipei-Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/285,028

(22) Filed: Sep. 29, 2008

(51) Int. Cl. F21V 5/04

(52) U.S. Cl. 362/330

(57) ABSTRACT

A light distribution board having an improved light grating structure including a plurality of light gratings each with multiple focuses, the light distribution board is used on a light outputting surface of a lamp, in which at least a transparent board is provided on at least one of its surfaces with a plurality of light gratings each having multiple focuses, each light grating having multiple focuses is composed of two or more arciform (concave or convex) lenses and at least one lens with a non-arciform surface to form a light grating having at least two focuses. With this structure, light beams can be uniformly distributed and can avoid the phenomenon of Gauss distribution that makes the area below the lamp especially bright, and avoid the phenomenon of dazzling of eyes during looking at the light emitting member in the lamp, and the light beams become more tender under the condition that lose of brightness is minimum.

### BACKGROUND OF THE INVENTION

1. Field of the Invention

The present invention relates to a light distribution board having an improved light grating structure including a plurality of light gratings each with multiple focuses; and especially to a light distribution board that can illuminate (by using the principles of optical reflection and refraction) a district with uniform brightness, tender light beams which are non dazzling under the condition of minimum lose of brightness of a lamp; the light distribution board is suitable to be applied to a place such as a house, an office, a factory or a road requiring illumination, and can achieve an effect of saving energy as well as avoiding the phenomenon of optical pollution.

2. Description of the Prior Art

Illuminating lamps generally are divided in to two kinds including indoor and outdoor lamps; indoor lamps mainly are installed each with a half covering type obscured cover 101 (referring to FIG. 1A) having on an inner side thereof a reflective surface 103; the light beams of the lamp include, in addition to those being directly irradiated from the lamp (light source), quite a large part of light beams being directly reflected from the reflective surface 103 and out of the lamp to a district to be illuminated. These lamps normally are treated by fogging process on the surface of the light source to avoid irradiating of light to eyes to result a phenomenon of making them feel dazzling and dizzy.

The outdoor lamps are mainly fully covering type covers (referring to FIG. 1B) in considering the factor of environment, they are mounted each therebeneath with a transparent hood 104, the hood 104 is also treated by fogging process to avoid the phenomenon of dazzling of eyes during looking at the light source directly. The aforesaid two types have a common defect of losing much brightness by treatment by fogging process, these kinds of conventional lamps generally have the phenomenon of Gauss distribution so that brightness of lamps are concentrated at an area exactly below each lamp.

Light grating boards available presently we know include rhombic gratings and convex lens gratings.

Referring to FIG. 2 depicting a conventional rhombic grating unit 201 of which the structure is more similar to that of the present invention, the rhombic grating unit 201 has a plane bottom surface 202, and a top surface having a plurality of saw toothed gratings 203, 204, the rhombic grating unit 201 is shaped from two straight bevel edges 205, 208 being oppositely disposed as mirror images for each other; several incident light beams 206 enter a bevel edge 205 of the saw toothed grating 203 in an identical incident angular direction to result a first time refraction, when the light beams 206 reach the plane surface 202, they are once more refracted toward a district 207 to be illuminated; similarly, several incident light beams 209 enter a bevel edge 208 of the saw toothed grating 204 in an identical incident angular direction to result a first time refraction, when the light beams 209 reach the plane surface 202, they are once more refracted toward a district 210 to be illuminated. We can see from the drawing that the light beams after being refracted from those incident light beams in an identical incident angular direction to the bevel edges 205, 208 or the plane surface 202 are always parallel to one another, i.e., there is no crossing and diffusing effect, the light beams arriving at the districts to be illuminated form partial gathering light beams, and they are unable to get an effect of uniformly distributing.

Referring to FIG. 3 which is depicted with another conventional convex lens grating unit 301 of which the structure is also more similar to that of the present invention, the convex lens grating unit 301 has a plane bottom surface 302, and a top surface having a plurality of convex lenses gratings 303, 304. Several incident light beams 305 enter the convex lens grating 303 in an identical incident angular direction to result a first time refraction, when the light beams 305 reach the plane surface 302, they are once more refracted toward a district 306 to be illuminated; similarly, several incident light beams 307 enter the convex lens grating 304 in an identical incident angular direction to result a first time refraction, when the light beams 307 reach the plane surface 302, they are once more refracted toward a district 308 to be illuminated. We can see from the drawing that the light beams after being irradiated to the two convex lens gratings 303, 304 in an identical incident angular direction will create refractions in different angular directions, wherein the convex lens grating 304 of a smaller curvature has a longer focus, the light beams after being refracted from the convex lens grating 304 cross at the focus, they form a narrower illuminated range at the district 308; the other convex lens grating 303 of a larger curvature has a shorter focus, the light beams after being refracted from the convex lens grating 303 cross at the focus, they form a wider illuminated range at the district 306. If the convex lens grating unit 301 is applied for light distribution, two defects as list below will be induced: firstly all light beams will gather at an area exactly below the convex lens grating unit 301, their distances of irradiation are short and they are unable to get an effect of having a wide illuminated range; and secondly, the light beams are highly overlapped with one another and are subjected to resulting the phenomenon of Gauss distribution, and are unable to get an effect of uniformly distributing.

Referring to FIG. 4 which shows a structure having a light distribution grating unit 401 having a plurality of saw tooth shaped gratings invented by the inventor of the present invention and having been filed as a Taiwan patent application with a filing no. 96140922; in which the light distribution grating unit 401 with multiple saw tooth shaped (gratings) has a plane bottom surface 402, and a top surface having a plurality of saw tooth shaped (gratings) 403, 404, 405, 406 and 407 each being composed of an arciform surface and a straight inclined surface (non-arciform surface), summarily, here we see a kind of arciform surface and a kind of non-arciform surface of which the saw tooth shaped (grating) 403 is composed of a convex lens (arciform surface) 423 and a straight inclined surface (non-arciform surface) 409.Several incident light beams 408 enter the straight inclined surface (non-arciform surface) 409 of the saw tooth shaped (grating) 403 to result a first time refraction, when the light beams 408 reach the plane surface 402, they are once more refracted down and leftwards toward a district 410 to be illuminated, the saw tooth shaped (grating) 404 is composed of a convex lens (arciform surface) 424 and a straight inclined surface (non-arciform surface) 412; similarly; several incident light beams 411 enter the straight inclined surface 412 of the saw tooth shaped (grating) 404 to result a first time refraction, when the light beams 411 reach the plane surface 402, they are once more refracted down and leftwards toward a district 413 to be illuminated; and more, several incident light beams 414 enter a convex lens (arciform surface) 415 of the saw tooth shaped (grating) 405 to result a first time refraction, when the light beams 415 reach the plane surface 402, they are once more refracted down and rightwards toward a district 416 to be illuminated, the saw tooth shaped (grating) 406 is composed of a convex lens (arciform surface) 418 and a straight inclined surface (non-arciform surface) 426; and several incident light beams 417 enter an arciform surface 418 of the saw tooth shaped (grating) 406 to result a first time refraction, when the light beams 417 reach the plane surface 402, they are once more refracted down and rightwards toward a district 419 to be illuminated, the saw tooth shaped (grating) 407 is composed of a convex lens (arciform surface) 421 and a straight inclined surface (non-arciform surface) 427; and several incident light beams 420 enter a convex lens (arciform surface) 421 of the saw tooth shaped (grating) 407 to result a first time refraction, when the light beams 420 reach the plane surface 402, they are once more refracted down and rightwards toward a district 422 to be illuminated; We can see from the drawing that the light beams 411 after being irradiated to the straight inclined surface (non-arciform surface) 412 having larger inclination angles in an identical incident angular direction will create larger refraction angles, i.e., the district 422 to be illuminated is farther right below the lamp; on the contrary, the light beams 408 after being irradiated to the straight inclined surface 409 having smaller inclination angles in an identical incident angular direction will create smaller refraction angles, i.e., the district 422 to be illuminated is nearer right below the lamp; the above two groups of light beams 411, 408 respectively are all parallel without crossing and diffusion, the light beams 411, 408 reaching the district 422 to be illuminated are in partially concentrated forms; the incident light beams 414 in an identical incident angular direction entering the arciform surface 415 (having same curvature but larger inclination angle) will create larger refraction angles and crossing state, i.e., the district 416 to be illuminated is farther right below the lamp, and the range of illumination in it is wider; on the contrary, the light beams 417 in an identical incident angular direction entering the convex lens (arciform surface) 418 (having same curvature but smaller inclination angle) will create smaller refraction angles and crossing state, i.e., the district 419 to be illuminated is nearer right below the lamp, and the range of illumination in it is narrower; the convex lenses (arciform surfaces) 415, 418 are arciform surfaces with same inclination angle but different curvatures; the light beams 420 in an identical incident angular direction entering the convex lens (arciform surface) 421 (having a larger curvature) cross at a focus with a shorter distance after refraction to result a wider range of illumination; on the contrary, the light beams 417 in an identical incident angular direction entering the convex lens (arciform surface) 418 (having a smaller curvature) cross at a focus with a longer distance after refraction result a narrower range of illumination.

Referring to FIG. 5, which shows a light distribution board structure having a plurality of gratings (each with multiple focuses) composed of at least two convex lenses also invented by the inventor of the present invention and having been filed as a US patent application with a filing Ser. No. 12/174,534; in which the light grating 501 with multiple focuses has a plane bottom surface 502, and a top surface having a plurality of light gratings 503, 504 and 505 each with multiple focuses, wherein the light grating 503 with multiple focuses is composed of two convex lenses (arciform surfaces) 506, 507 of same curvature and size, the light grating 504 with multiple focuses is composed of two convex lenses (arciform surfaces) 508, 509 of same curvature but different sizes, the light grating 505 with multiple focuses is composed of three convex lenses (arciform surfaces) 510, 511 and 512 of different curvatures and different sizes; wherein curvature and size of each convex lens (arciform surface)are changed in pursuance of the angles of refraction of the light beams and the range being illuminated.

### SUMMARY OF THE INVENTION

In order to get rid of the defects of the conventional lamps, the present invention provided a light distribution board having an improved light grating structure including a plurality of light gratings each with multiple focuses, the light distribution board can be mounted at a light outputting surface of a conventional lamp to control the refraction angular directions of most of the light beams of the lamp, so that the light beams can irradiate a predetermined district to be illuminated to get an effect of uniformly distributing. At least a transparent board is provided on its top surface with a plurality of light gratings each having multiple focuses, each light grating having multiple focuses is composed of two or more concave or convex lenses and at least one lens each with a non-arciform surface, to form a convex lens grating having two or more focuses; these light gratings with multiple focuses are strip like light gratings; the top surface is a light receiving surface of the lamp. The bottom surface of the transparent board can be a plane surface or is formed thereon a plurality of normal convex lenses, an arciform surface or a surface formed thereon a plurality of normal convex lenses, and the bottom surface is an illuminating surface of the lamp. With such a structure, light beams can be uniformly distributed and can avoid the phenomenon of Gauss distribution that makes the area below the lamp especially bright, and can avoid the phenomenon of dazzling of eyes during looking at the light emitting member in the lamp, and the light beams become more tender under the condition that lose of brightness is minimum.

Moreover, the light distribution board having an improved light grating structure provided in the present invention can be formed on a top surface of a transparent board a plurality of light gratings each having multiple focuses, each light grating having multiple focuses is composed of two or more concave or convex lenses and at least one lens each with a non-arciform surface to form a light grating unit having two or more focuses; these light gratings with multiple focuses are annular light gratings; the top surface is a light receiving surface of the lamp. The bottom surface of the transparent board can be a plane surface or a surface formed thereon a plurality of normal convex lenses, and the bottom surface is an illuminating surface of the lamp.

Further, the light distribution board having an improved light grating structure provided in the present invention can be formed on a top surface of a transparent board a plurality of light gratings each having multiple focuses, each light grating having multiple focuses is composed of two or more concave or convex lenses and at least one lens each with a non-arciform surface to form a convex lens grating having two or more focuses; these light gratings with multiple focuses are light gratings in shapes of clouds; the top surface is a light receiving surface of the lamp. The bottom surface of the transparent board can be a plane surface or a surface formed thereon a plurality of normal convex lenses, and the bottom surface is an illuminating surface of the lamp.

In a light distribution board having an improved light grating structure provided in the present invention, curvature and inclination angle of each concave or convex lens of a light grating having multiple focuses and inclination angle of the aforesaid at least one lens each with a non-arciform surface are changed in pursuance of the angles of refraction of the incident light beams through the lens surfaces. While curvature of every normal convex lens and the inter-lens distance between every two normal convex lenses are changed in pursuance of the angles of refraction of the incident light beams through the lens surfaces. Thereby light beams in a lamp can be refracted toward a small area of the district to be illuminated, thus light beams can be uniformly distributed and can avoid the phenomenon of Gauss distribution that makes the area below the lamp especially bright.

The light distribution board having an improved light grating structure provided in the present invention can be further improved, namely, partial areas of the bottom surface of the transparent board can be formed a plurality of normal convexes; and partial areas can be formed a plurality of convex lens gratings with multiple focuses. With such a structure, a wider illuminated range can be provided, light beams can be uniformly distributed, the phenomenon of dazzling of eyes during looking at the light emitting member in the lamp can be avoided, and the light beams become more tender under the condition that lose of brightness is minimum.

The present invention will be apparent in its structure and principle after reading the detailed description of the preferred embodiment thereof in reference to the accompanying drawings.

### BRIEF DESCRIPTION OF THE DRAWINGS

FIG. 1A is a schematic sectional view of a conventional half covering type illumination lamp;

FIG. 1B is a schematic sectional view of a conventional fully covering type illumination lamp;

FIG. 2 is a schematic view showing the light beam progressing of a conventional rhombic grating structure;

FIG. 3 is a schematic view showing the light beam progressing of a conventional convex lens grating;

FIG. 4 is a schematic view showing a light grating structure having a plurality of saw toothed lenses;

FIG. 5 shows a light grating structure composed of at least two convex lenses (at least with two focuses);

FIGS. 6, 6A show a light grating having multiple focuses of the present invention being composed of two convex lenses and a non-arciform surface;

FIGS. 7, 7A show a light grating having multiple focuses of the present invention also being composed of two convex lenses and a non-arciform surface;

FIGS. 8, 8A show a light grating having multiple focuses of the present invention being composed of two convex lenses and two non-arciform surfaces;

FIGS. 9, 9A show a light grating having multiple focuses of the present invention also being composed of two convex lenses and two non-arciform surfaces;

FIGS. 10, 10A show a light grating having multiple focuses of the present invention being composed of three convex lenses and a non-arciform surfaces;

FIGS. 11, 11A show a light grating having multiple focuses of the present invention being composed of two convex lenses and three non-arciform surfaces;

FIG. 12 is an enlarged schematic view showing a light distribution board of the present invention having an improved light grating structure with a plurality of light gratings each having multiple focuses;

FIGS. 13, 13A and 13B are plane views of a first embodiment of a light distribution board of the present invention having an improved light grating structure with a plurality of light gratings each having multiple focuses;

FIGS. 14, 14A and 14B are plane views of a second embodiment of a light distribution board of the present invention having an improved light grating structure with a plurality of light gratings each having multiple focuses;

FIGS. 15, 15A and 15B are plane views of a third embodiment of a light distribution board of the present invention having an improved light grating structure with a plurality of light gratings each having multiple focuses;

FIGS. 16, 16A and 16B are plane views of a fourth embodiment of a light distribution board of the present invention having an improved light grating structure with a plurality of light gratings each having multiple focuses;

FIGS. 17, 17A and 17B are plane views of a fifth embodiment of a light distribution board of the present invention having an improved light grating structure with a plurality of light gratings each having multiple focuses;

FIGS. 18 and 18A are plane views of a sixth embodiment of a light distribution board of the present invention; the present invention having an improved light grating structure with a plurality of light gratings each having multiple focuses;

FIGS. 19, 19A are plane views of a seventh embodiment of a light distribution board of the present invention having an improved light grating structure with a plurality of light gratings each having multiple focuses;

FIGS. 20, 20A and 20B are plane views of a eighth embodiment of a light distribution board of the present invention having an improved light grating structure with a plurality of light gratings each having multiple focuses;

FIGS. 21, 21A and 21B are plane views of a ninth embodiment of a light distribution board of the present invention having an improved light grating structure with a plurality of light gratings each having multiple focuses;

FIGS. 22, 22A and 22 B are plane views of a tenth embodiment of a light distribution board of the present invention having an improved light grating structure with a plurality of light gratings each having multiple focuses;

FIGS. 23, 23A and 23B are plane views of a eleventh embodiment of a light distribution board of the present invention having an improved light grating structure with a plurality of light gratings each having multiple focuses;

FIGS. 24 and 24A are plane views of a twelfth embodiment of a light distribution board of the present invention having an improved light grating structure with a plurality of light gratings each having multiple focuses;

FIG. 25 is a sectional view showing an embodiment of which at least a side of a transparent board of the present invention is used to form a light distribution board having a plurality of light gratings each with multiple focuses and is applied to a lamp;

FIG. 26 is a sectional view showing another embodiment of which at least a side of a transparent board of the present invention is used to form a light distribution board having a plurality of light gratings each with multiple focuses and is applied to a lamp;

FIGS. 27, 27A show a light grating having multiple focuses of the present invention being composed of two concave lenses and a non-arciform surface;

FIGS. 28, 28A show another light grating having multiple focuses of the present invention being composed of two concave lenses and a non-arciform surface;

FIGS. 29, 29A show a light grating having multiple focuses of the present invention being composed of two concave lenses and two non-arciform surfaces;

FIGS. 30, 30A show a light grating having multiple focuses of the present invention being composed of a convex lens, a concave lens and a non-arciform surface;

FIGS. 31, 31A show another light grating having multiple focuses of the present invention being composed of t a convex lens, a concave lens and a non-arciform surface;

FIGS. 32, 32A show a light grating having multiple focuses of the present invention being composed of a convex lens, a concave lens and two non-arciform surfaces.

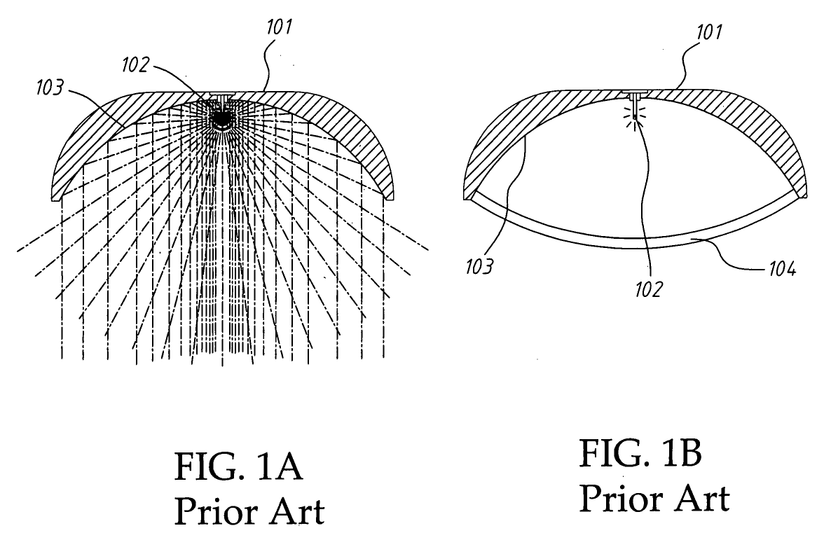

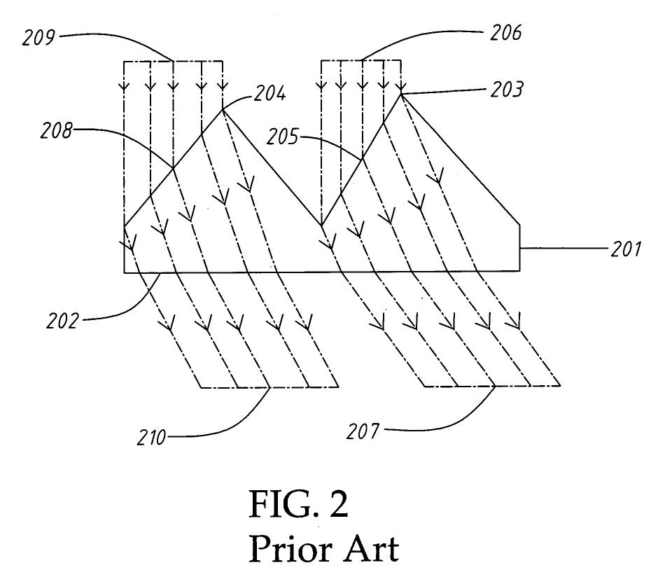

### DETAILED DESCRIPTION OF THE PREFERRED EMBODIMENT

The present invention relates a light distribution board having an improved light grating structure with multiple focuses, in which at least a transparent board is used to form the light distribution board as an illuminating cover for a lamp. The transparent board can be in the shape of rectangular, circle, elliptical or strange shape; the material for the transparent board can be transparent plastics, transparent glass or some other transparent material. The transparent board is formed on at least one side thereof a plurality of light gratings each having multiple focuses, each of the light gratings having multiple focuses is composed of two or more convex lenses and at least one lens each with a non-arciform surface to form a convex lens grating having two or more focuses, curvature and inclination angle of each convex lens and inclination angle of the aforesaid at least one lens each with a non-arciform surface are changed in pursuance of the angles of refraction of the incident light beams through the lens surfaces.

The present invention is described with many embodiments below:

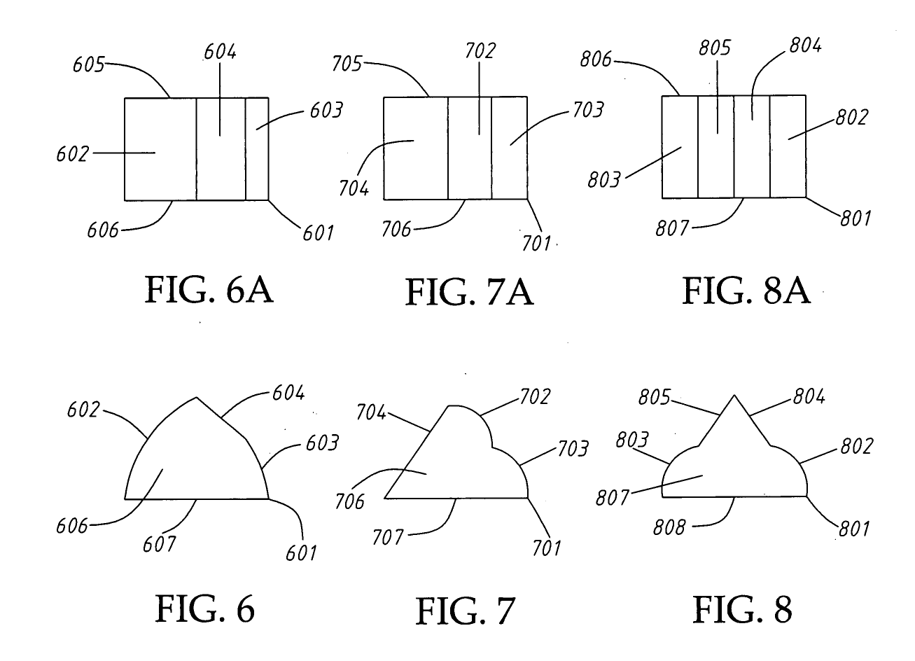

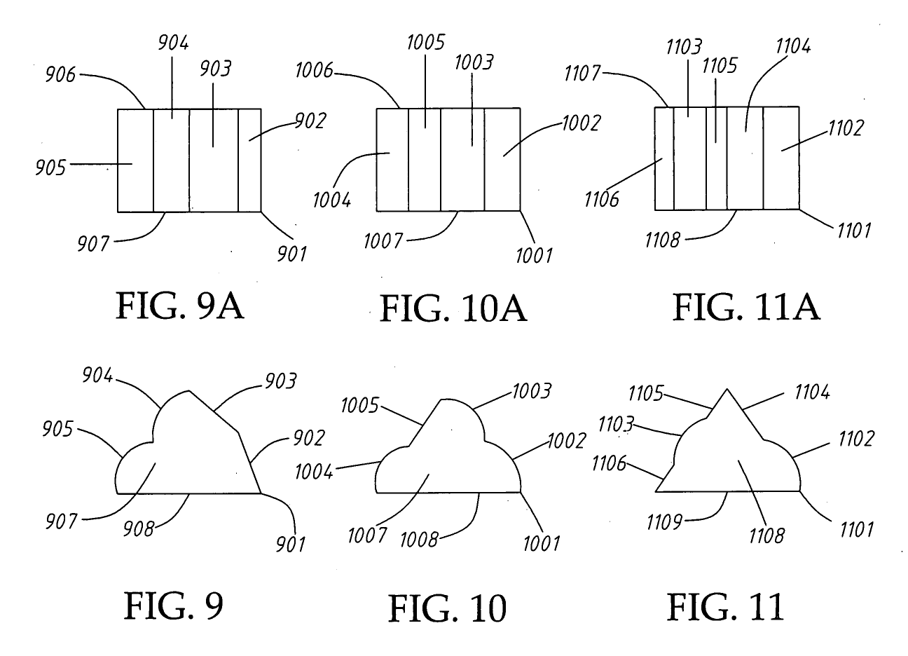

The light gratings having multiple focuses in strip, annular, cloud or granular shapes formed from the transparent boards of the present invention are chosen from the following various structures:
1. Referring to FIGS. 6 and 6A, in the drawings, a light grating 602 having multiple focuses is composed of two convex lenses 602 and 603 and a lens with a non-arciform surface 604, and there are two surfaces 605, 606 which are vertical surfaces of the front and the rear sides respectively of the light grating 601 which is strip like, cloud shaped or annular, and a bottom surface 607 of the light grating 601 having multiple focuses is a plane surface.
2. Referring to FIGS. 7 and 7A, in the drawings, a light grating 701 having multiple focuses is composed of two convex lenses 702, and 703 and a lens with a non-arciform surface 704, and there are two surfaces 705 and 706 which are vertical surfaces of the front and the rear sides respectively of the light grating 701 which is strip like, cloud shaped or annular, and a bottom surface 707 of the light grating 701 having multiple focuses is a plane surface.
3. Referring to FIGS. 8 and 8A, in the drawings, a light grating 801 having multiple focuses is composed of two convex lenses 802 and 803 and two lenses each with a non-arciform surface 804, 805 and there are two surfaces 806, 807 which are vertical surfaces of the front and the rear sides respectively of the light grating 801 which is strip like, cloud shaped or annular, and a bottom surface 808 of the light grating 801 having multiple focuses is a plane surface.
4. Referring to FIGS. 9 and 9A, in the drawings, a light grating 901 having multiple focuses is composed of two convex lenses 904 and 905 and two lenses each with a non-arciform surface 802, 803, and there are two surfaces 906, 907 which are vertical surfaces of the front and the rear sides respectively of the light grating 901 which is strip like, cloud shaped or annular, and a bottom surface 908 of the light grating 901 having multiple focuses is a plane surface.
5. Referring to FIGS. 10 and 10A, in the drawings, a light grating 1001 having multiple focuses is composed of three convex lenses 1002, 1003 and 1004 and a lens with a non-arciform surface 1005, and there are two surfaces 1006, 1007 which are vertical surfaces of the front and the rear sides respectively of the light grating 1001 which is strip like, cloud shaped or annular, and a bottom surface 1008 of the light grating 1001 having multiple focuses is a plane surface.
6. Referring to FIGS. 11 and 11A, in the drawings, a light grating 1101 having multiple focuses is composed of two convex lenses 1102, 1103 and three lenses each with a non-arciform surface 1104, 1105 and 1106, and there are two surfaces 1107, 1108 which are vertical surfaces of the front and the rear sides respectively of the light grating 1101 which is strip like, cloud shaped or annular, and a bottom surface 1108 of the light grating 1101 having multiple focuses is a plane surface.

By virtue that there are many kinds of light grating structures composed of convex lenses, here we summarily list the above six kinds of composed structures, generally speaking, a convex lens grating having two or more convex lenses and at least one lens each with a non-arciform surface, and being in strip, cloud, or annular shapes all fall in the scope of the light gratings with multiple focuses formed from the transparent boards of the present invention.

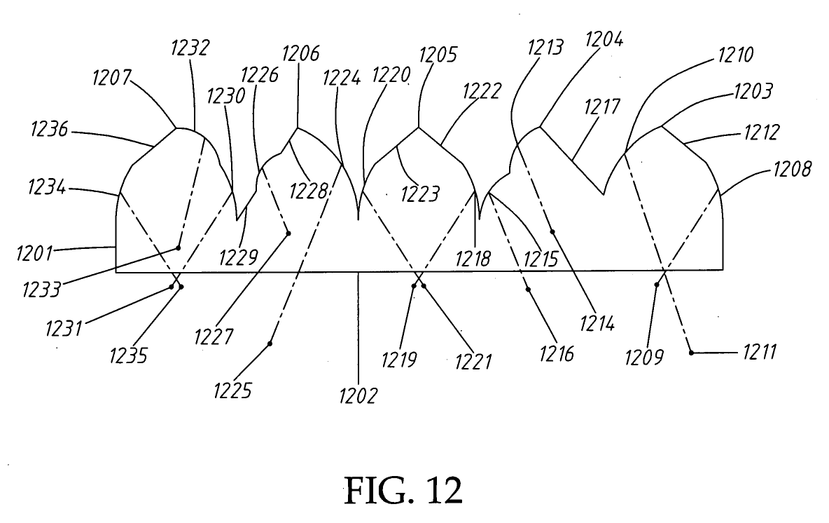

Referring to FIG. 12 which is an enlarged schematic view showing a light distribution board 1201 having an improved light grating structure with a plurality of light gratings each having multiple focuses and in strip, annular, cloud or granular shapes presented in partial sectional view of the present invention; in the drawing, a bottom surface 1202 of the light distribution board 1201 is a plane surface, and the top surface of the light distribution board 1201 is formed thereon a plurality of light gratings (having multiple focuses) 1203, 1204, 1205, 1206 and 1207, wherein the light grating (having multiple focuses) 1203 is composed of two convex lenses 1208, 1210 and a non-arciform surface 1212; the convex lens 1208 having multiple focuses has a focus 1209, the other convex lens 1210 has a focus 1211; the light gratings 1204 is composed of two convex lenses 1213, 1215 and a non-arciform surface 1217; the convex lens 1213 having multiple focuses has a focus 1214, the other convex lens 1215 has a focus 1216; the convex lens 1205 having multiple focuses is composed of two convex lenses 1218, 1220 and two non-arciform surfaces 1222, 1223, the convex lens 1220 has a focus 1221, the convex lens 1206 having multiple focuses is composed of two convex lenses 1224, 1226 and two non-arciform surfaces 1228, 1229, of which the convex lens 1224 has a focus 1225, the other convex lens 1226 has a focus 1227; the convex lens 1207 having multiple focuses is composed of three convex lenses 1230, 1232, 1234 and a non-arciform surface 1236, the convex lens 1230 has a focus 1231, the convex lens 1232 has a focus 1233, and the convex lens 1234 has a focus 1235.

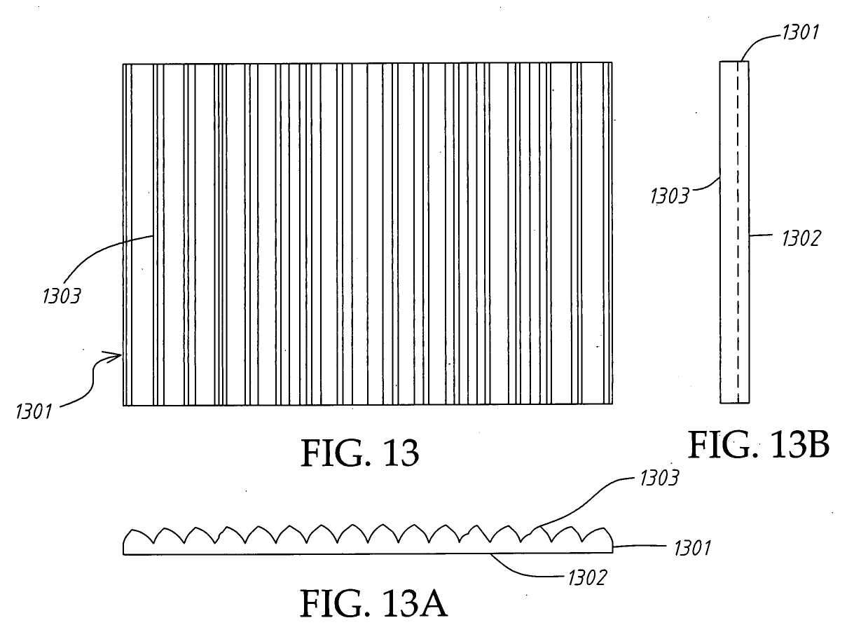

Referring to FIGS. 13, 13A and 13B which are plane views of a first embodiment of light distribution board having an improved light grating structure with a plurality of light gratings each having multiple focuses of the present invention, in the drawings, a bottom surface 1302 of a transparent board 1301 is a plane surface, and a top surface of the transparent board 1301 is formed thereon a plurality of strip like light gratings 1303 each having multiple focuses. The curvature and inclination angle of each convex lens of the strip like light gratings 1303 having multiple focuses and the inclination angle of each of the aforesaid lenses with a non-arciform surface are changed in pursuance of the angles of refraction of the incident light beams through the lens surfaces.

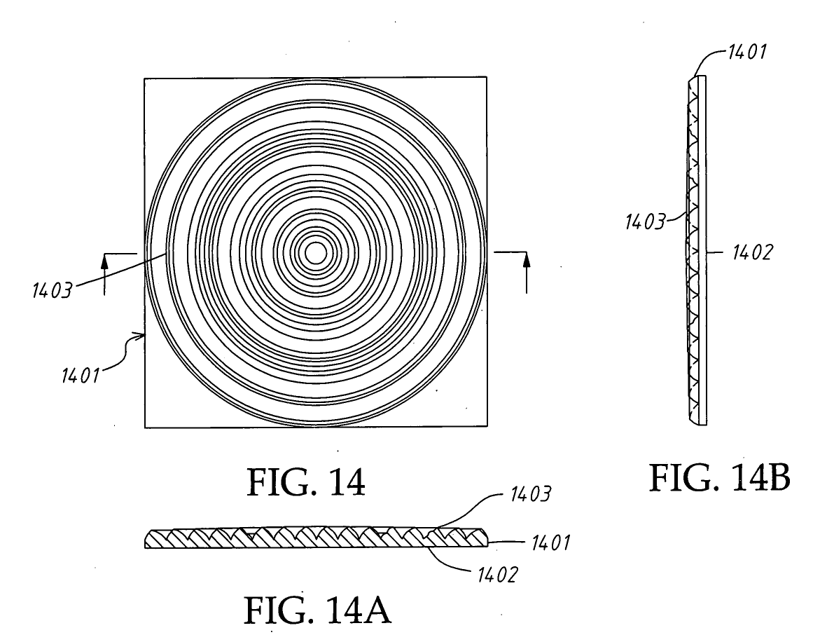

Referring to FIGS. 14, 14A and 14B which are plane views of a second embodiment of light distribution board having an improved light grating structure with a plurality of light gratings each having multiple focuses of the present invention, in the drawings, a bottom surface 1402 of a transparent board 1401 is a plane surface, and a top surface of the transparent board 1401 is formed thereon a plurality of annular light gratings 1403 each having multiple focuses. The curvature and inclination angle of each convex lens of the annular light gratings 1403 having multiple focuses and the inclination angle of each of the aforesaid lenses with a non-arciform surface are changed in pursuance of the angles of refraction of the incident light beams through the lens surfaces.

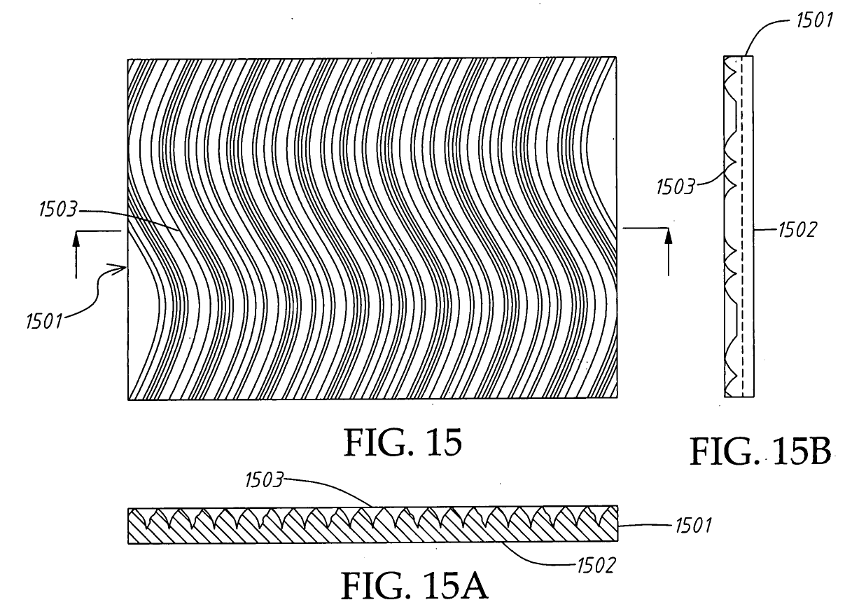

Referring to FIGS. 15, 15A and 15B which are plane views of a third embodiment of light distribution board having an improved light grating structure with a plurality of light gratings each having multiple focuses of the present invention, in the drawings, a bottom surface 1502 of a transparent board 1501 is a plane surface, and a top surface of the transparent board 1501 is formed thereon a plurality of cloud shaped light gratings 1503 each having multiple focuses. The curvature and inclination angle of each convex lens of the cloud shaped light gratings 1503 having multiple focuses and the inclination angle of each of the aforesaid lenses with a non-arciform surface are changed in pursuance of the angles of refraction of the incident light beams through the lens surfaces.

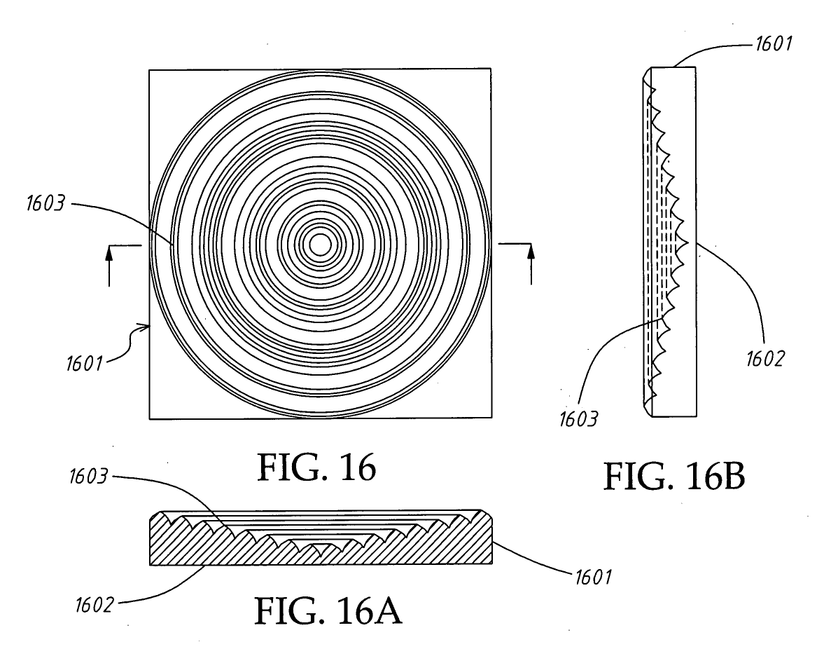

Referring to FIGS. 16, 16A and 16B which are plane views of a fourth embodiment of light distribution board having an improved light grating structure with a plurality of light gratings each having multiple focuses of the present invention, in the drawings, a bottom surface 1602 of a transparent board 1601 is a plane surface, and a top surface of the transparent board 1601 is formed thereon a plurality of annular light gratings 1603 each having multiple focuses. These annular light gratings 1603 having multiple focuses are arranged in steps. The curvature and inclination angle of each convex lens of the annular light gratings 1603 having multiple focuses and the inclination angle of each of the aforesaid lenses with a non-arciform surface are changed in pursuance of the angles of refraction of the incident light beams through the lens surfaces.

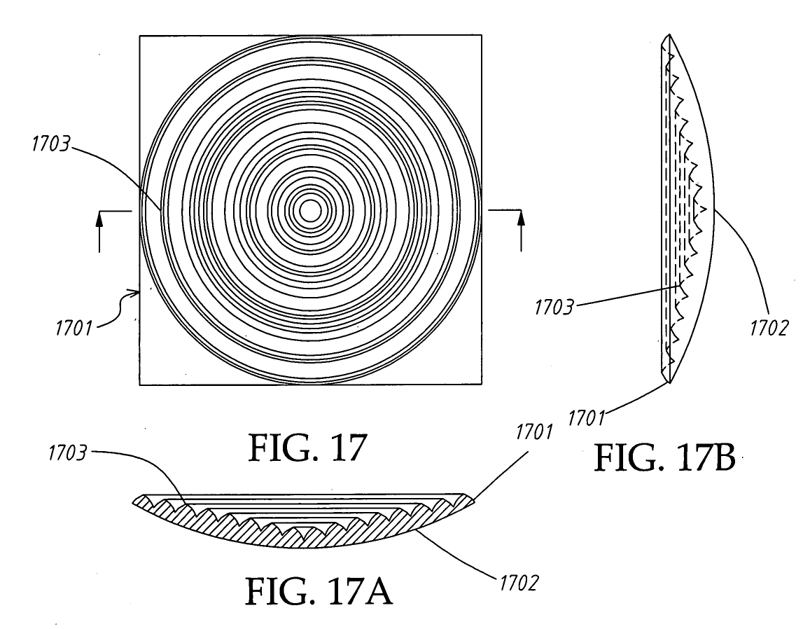

Referring to FIGS. 17, 17A and 17B which are plane views of a fifth embodiment of light distribution board having an improved light grating structure with a plurality of light gratings each having multiple focuses of the present invention, in the drawings, a bottom surface 1702 of a transparent board 1701 is an arciform surface, and a top surface of the transparent board 1701 is formed thereon a plurality of annular light gratings 1703 each having multiple focuses. These annular light gratings 1703 having multiple focuses are arranged in steps. The curvature and inclination angle of each convex lens of the annular light gratings 1703 having multiple focuses and the inclination angle of each of the aforesaid lenses with a non-arciform surface are changed in pursuance of the angles of refraction of the incident light beams through the lens surfaces.

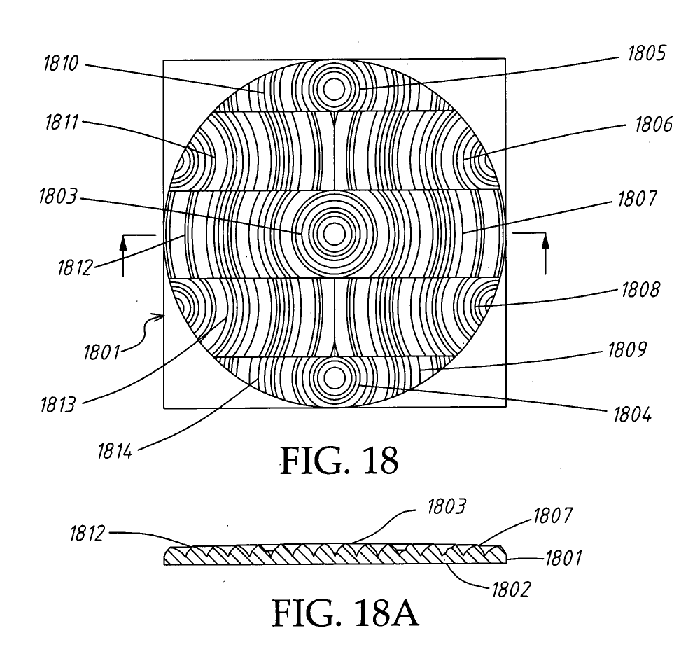

Referring to FIGS. 18 and 18A which are plane views of a sixth embodiment of light distribution board having an improved light grating structure with a plurality of light gratings each having multiple focuses of the present invention, in the drawings, a bottom surface 1802 of a transparent board 1801 is a plane surface, and a top surface of the transparent board 1801 is formed thereon a plurality of non-concentric annular light gratings 1803, 1804 and 1805 all having multiple focuses and a plurality of partially annular light gratings 1806, 1807, 1808, 1809, 1810, 1811, 1812, 1813 and 1814 all having multiple focuses. The curvature and inclination angle of each convex lens of the annular light gratings 1803 having multiple focuses and the inclination angle of each of the aforesaid lenses with a non-arciform surface are changed in pursuance of the angles of refraction of the incident light beams through the lens surfaces.

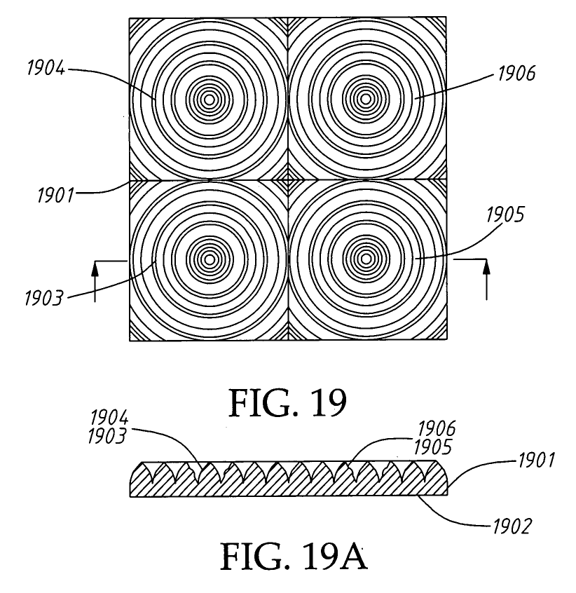

Referring to FIGS. 19 and 19A which are plane views of a seventh embodiment of light distribution board having an improved light grating structure with a plurality of light gratings each having multiple focuses of the present invention, in the drawings, a bottom surface 1902 of a transparent board 1901 is a plane surface, and a top surface of the transparent board 1901 is thereon a plurality of non-concentric annular light gratings 1903, 1904, 1905 and 1906 all having multiple focuses. The curvature and inclination angle of each convex lens of the annular light gratings 1803 having multiple focuses and the inclination angle of each of the aforesaid lenses with a non-arciform surface are changed in pursuance of the angles of refraction of the incident light beams through the lens surfaces.

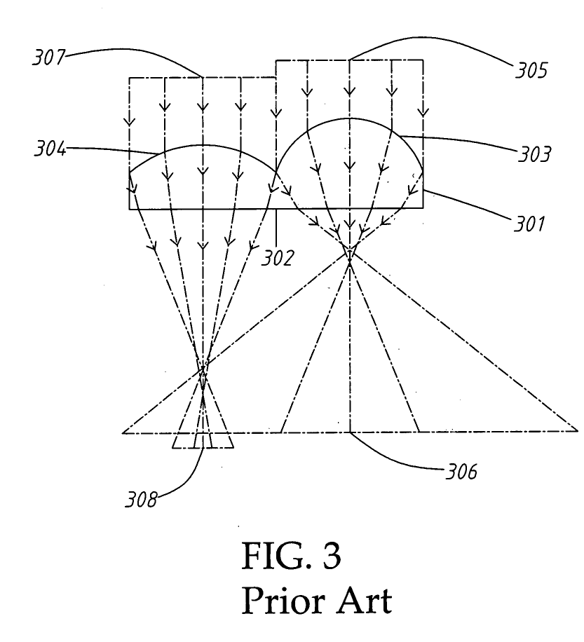

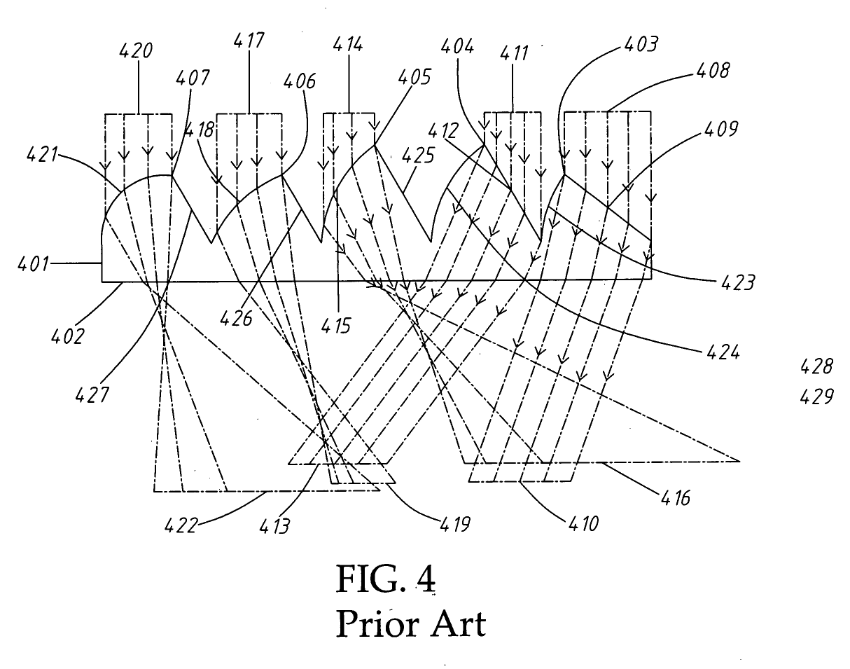

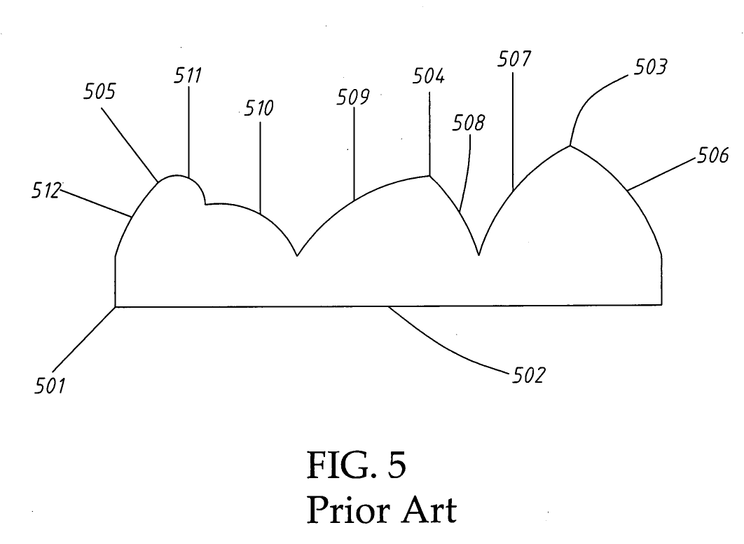

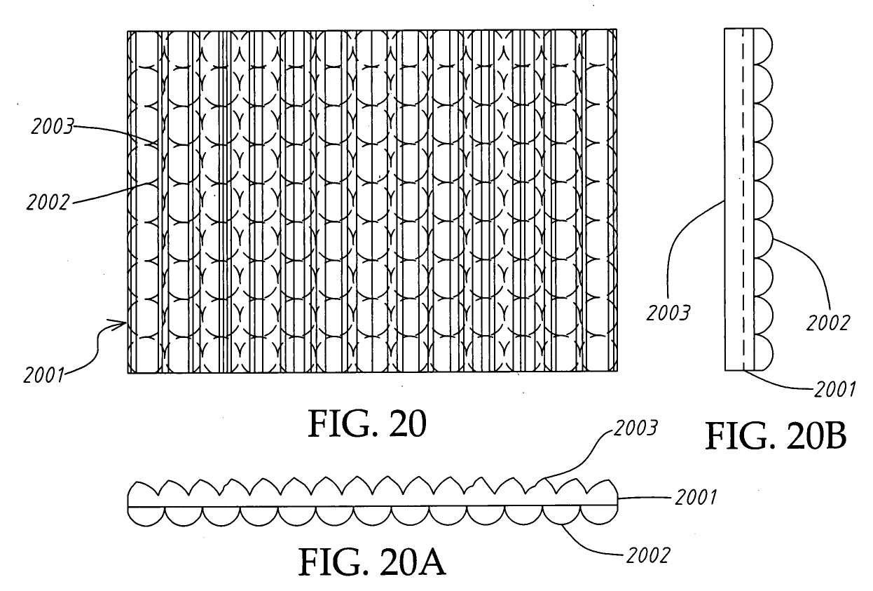

Referring to FIGS. 20, 20A and 20B which are plane views of an eighth embodiment of light distribution board having an improved light grating structure with a plurality of light gratings each having multiple focuses of the present invention, in the drawings, a bottom surface of a transparent board 2001 is formed thereon a plurality of normal convex lenses 2002, and a top surface of the transparent board 2001 is formed thereon a plurality of strip like light gratings 2003 each having multiple focuses. The curvature and inclination angle of each convex lens of the strip like light gratings 2003 having multiple focuses and the inclination angle of each of the aforesaid lenses with a non-arciform surface are changed in pursuance of the angles of refraction of the incident light beams through the lens surfaces. The principle of designing the curvatures of the normal convex lenses 2002 is same as that stated for FIG. 3.

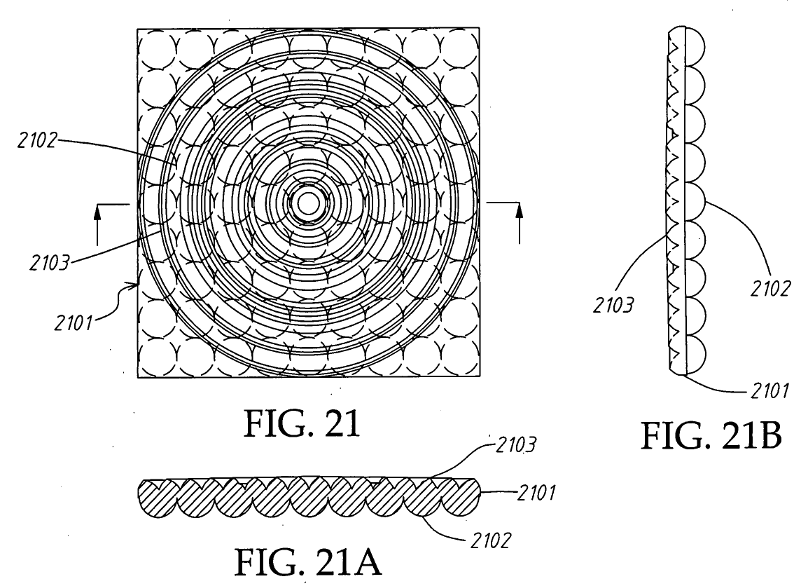

Referring to FIGS. 21, 21A and 21B which are plane views of a ninth embodiment of light distribution board having an improved light grating structure with a plurality of light gratings each having multiple focuses of the present invention, in the drawings, a bottom surface of a transparent board 2101 is formed thereon a plurality of normal convex lenses 2102, and a top surface of the transparent board 2101 is formed thereon a plurality of annular light gratings 2103 each having multiple focuses. The curvature and inclination angle of each convex lens of the annular light gratings 2103 having multiple focuses and the inclination angle of each of the aforesaid lenses with a non-arciform surface are changed in pursuance of the angles of refraction of the incident light beams through the lens surfaces. The principle of designing the curvatures of the normal convex lenses 2102 is same as that stated for FIG. 3.

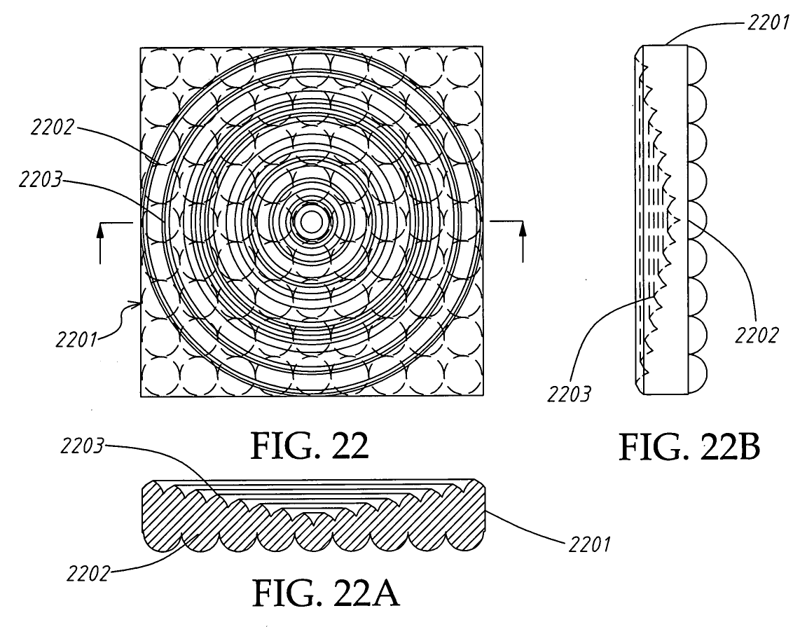

Referring to FIGS. 22, 22A and 22B which are plane views of a tenth embodiment of light distribution board having an improved light grating structure with a plurality of light gratings each having multiple focuses of the present invention, in the drawings, a bottom surface of a transparent board 2201 is formed thereon a plurality of normal convex lenses 2202, and a top surface of the transparent board 2201 is formed thereon a plurality of annular light gratings 2203 each having multiple focuses. These annular light gratings 2203 having multiple focuses are arranged in steps. The curvature and inclination angle of each convex lens of the annular light gratings 2203 having multiple focuses and the inclination angle of each of the aforesaid lenses with a non-arciform surface are changed in pursuance of the angles of refraction of the incident light beams through the lens surfaces. The principle of designing the curvatures of the normal convex lenses 2202 is same as that stated for FIG. 3.

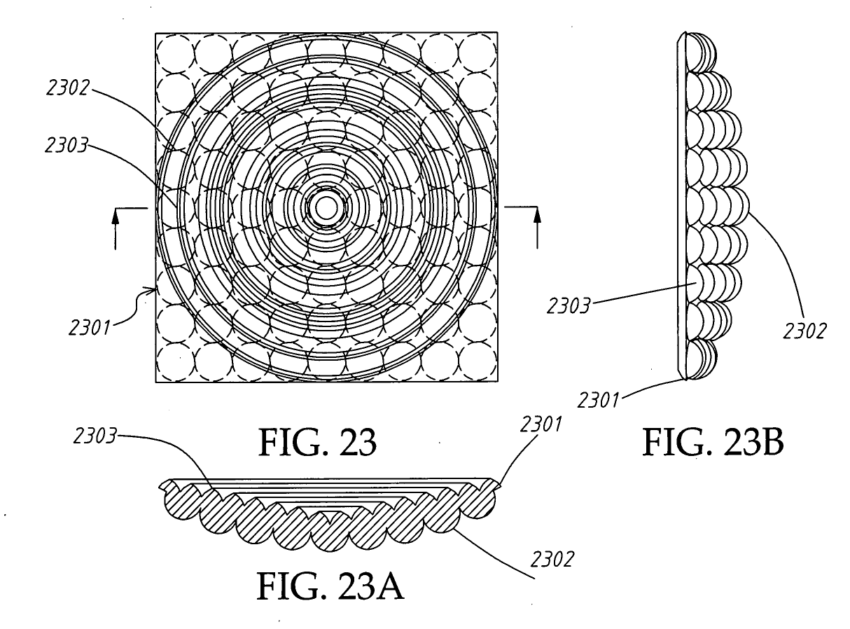

Referring to FIGS. 23, 23A and 23B which are plane views of an eleventh embodiment of light distribution board having an improved light grating structure with a plurality of light gratings each having multiple focuses of the present invention, in the drawings, a bottom surface of a transparent board 2301 is formed thereon a plurality of normal convex lenses 2302, and a top surface of the transparent board 2301 is formed thereon a plurality of annular light gratings 2303 each having multiple focuses. These annular light gratings 2303 having multiple focuses are arranged in steps. The curvature and inclination angle of each convex lens of the annular light gratings 2303 having multiple focuses and the inclination angle of each of the aforesaid lenses with a non-arciform surface are changed in pursuance of the angles of refraction of the incident light beams through the lens surfaces. The principle of designing the curvatures of the normal convex lenses 2302 is same as that stated for FIG. 3.

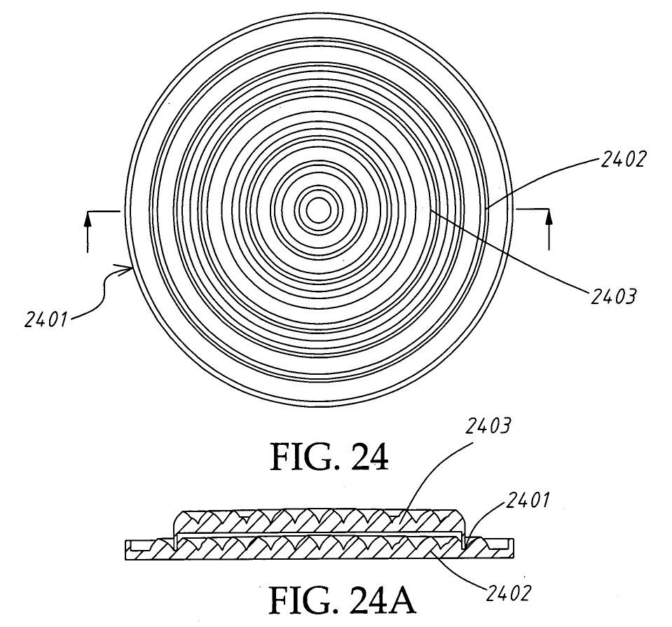

Referring to FIGS. 24, and 24A which are plane views of a twelfth embodiment of light distribution board having an improved light grating structure with a plurality of light gratings each having multiple focuses of the present invention, in the drawings, there is a two-layer light distribution board 2401 composed of two transparent boards 2402, 2403 of which one overlaps the other, each of the two transparent boards 2402, 2403 can be as any of the above eleven kinds of embodiments of light distribution boards. In the drawings, the two transparent boards 2402, 2403 as shown here are both the transparent boards for the annular light gratings having multiple focuses as stated in the second embodiment, with such a structure, light beams can get maximum angles of refraction after many times of refraction.

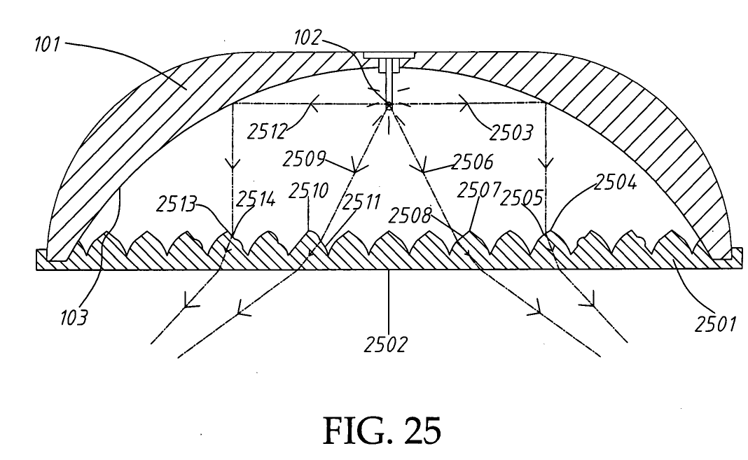

Referring to FIG. 25 which shows an embodiment of the present invention, of which at least a side of at least a transparent board is used to form a light distribution board with a plurality of light gratings each having multiple focuses and is applied to a lamp, in which a light distribution board randomly chosen from any of the above first to eleventh embodiments is movably mounted at a district to be illuminated below the conventional half covering type obscured cover 101; in this drawing, a light distribution board 2501 as that of the second embodiment of the present invention is used for an example, a top surface of the light distribution board 2501 is formed thereon a plurality of annular light gratings each having multiple focuses and faces to a light source 102 being a light receiving surface, a bottom surface 2502 of the light distribution board 2501 is a plane surface as a light outputting surface.

When a light beam 2506 enters a convex lens 2508 of the light distribution board 2507 to create a first time refraction, and when the light beam 2506 reaches the plane surface 2502, it is once more refracted down and rightwards toward a district to be illuminated. A light beam 2509 enters a convex lens 2511 of a light grating 2510 of the light distribution board 2501 to create a first time refraction, and when the light beam 2509 reaches the plane surface 2502, it is once more refracted down and leftwards and enters the district to be illuminated. A light beam 2503 enters a convex lens 2505 of a light grating 2504 of the light distribution board 2501 after being reflected by a reflective surface 103 to create a first time refraction, and when the light beam 2503 reaches the plane surface 2502, it is once more refracted down and rightwards and enters the district to be illuminated. A light beam 2512 enters a convex lens 2514 of a light grating 2513 of the light distribution board 2501 after being reflected by the reflective surface 103 to create a first time refraction, and when the light beam 2512 reaches the plane surface 2502, it is once more refracted down and leftwards and enters the district to be illuminated. The light distribution board 2501 definitely can control illumination of a specific district to be illuminated by most of the light beams from the lamp, and the effects of having a wider illuminated range and uniform distribution of brightness of light beams at the district to be illuminated can thus be obtained, and an effect of saving energy can thus be achieved.

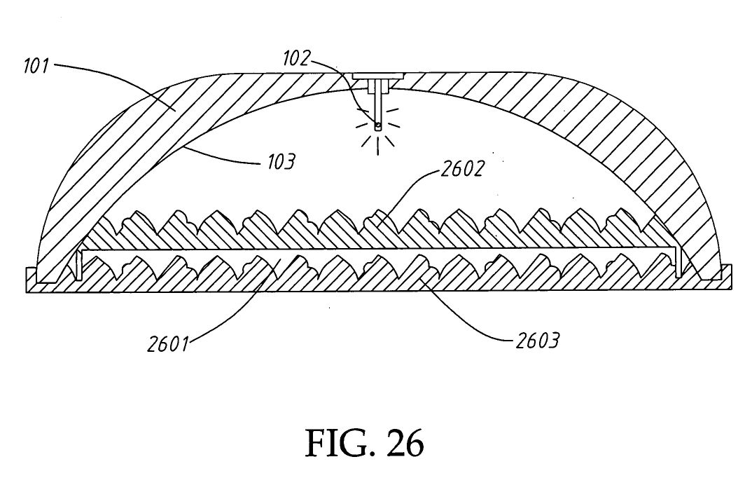

Referring to FIG. 26 which shows another embodiment of the present invention, of which at least a side of at least a transparent board is used to form a light distribution board with a plurality of light gratings each having multiple focuses and is applied to a lamp, in which a light distribution board 2601 chosen from the above twelfth embodiment is movably mounted at a district to be illuminated below the conventional half covering type obscured cover 101; in this drawing, the light distribution board 2601 is formed from two transparent boards 2602, 2603 of which one overlaps the other.

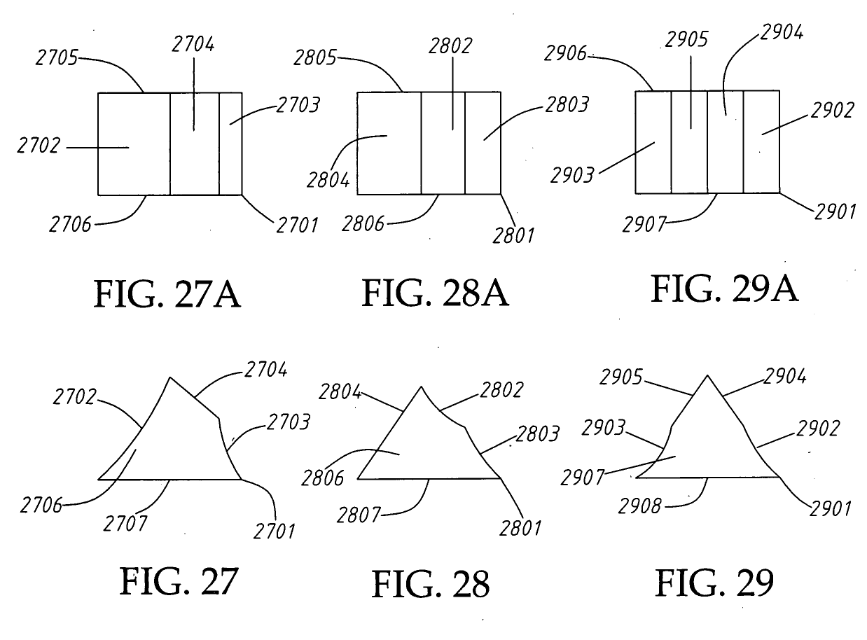

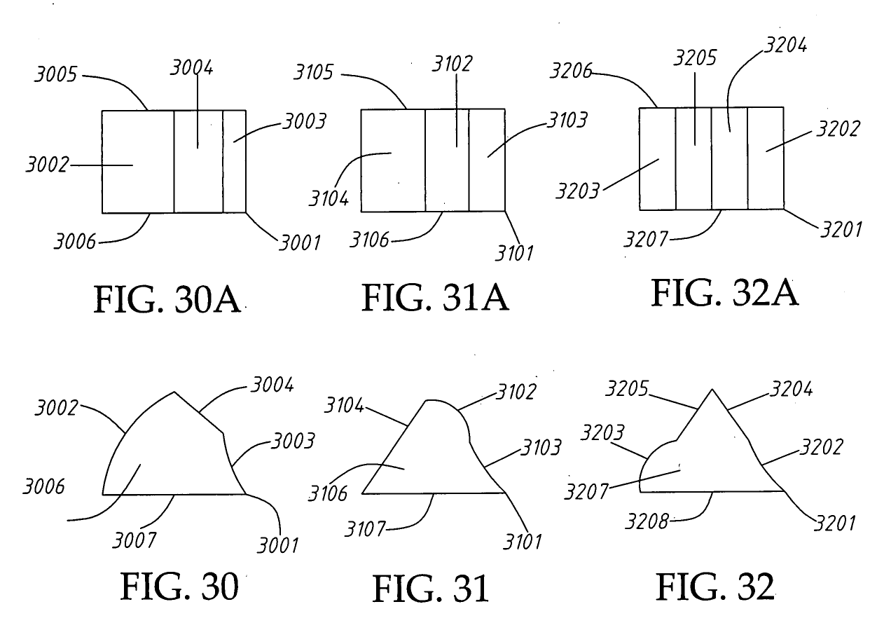

The light gratings having multiple focuses in strip, annular, cloud or granular shapes formed from the transparent boards of the present invention can also be chosen from the above various structures:
1. Referring to FIGS. 27 and 27A, in the drawings, a light grating 2701 having multiple focuses is composed of two concave lenses 2702 and 2703 and a lens with a non-arciform surface 2704, and there are two surfaces 2705, 2706 which are vertical surfaces of the front and the rear sides respectively of the light grating 2701 which is strip like, cloud shaped or annular, and a bottom surface 2707 of the light grating 2701 having multiple focuses is a plane surface.
2. Referring to FIGS. 28 and 28A, in the drawings, a light grating 2801 having multiple focuses is composed of two concave lenses 2802, and 2803 and a lens with a non-arciform surface 2804, and there are two surfaces 2805 and 2806 which are vertical surfaces of the front and the rear sides respectively of the light grating 2801 which is strip like, cloud shaped or annular, and a bottom surface 2807 of the light grating 2801 having multiple focuses is a plane surface.
3. Referring to FIGS. 29 and 29A, in the drawings, a light grating 2901 having multiple focuses is composed of two concave lenses 2902 and 2903 and two lenses each with a non-arciform surface 2904, 2905 and there are two surfaces 2906, 2907 which are vertical surfaces of the front and the rear sides respectively of the light grating 2901 which is strip like, cloud shaped or annular, and a bottom surface 2908 of the light grating 2901 having multiple focuses is a plane surface.
4. Referring to FIGS. 30 and 30A, in the drawings, a light grating 3001 having multiple focuses is composed of a convex lens 3002, a concave lens 3003 and a lens with a non-arciform surface 3004, and there are two surfaces 3005, 3006 which are vertical surfaces of the front and the rear sides respectively of the light grating 3001 which is strip like, cloud shaped or annular, and a bottom surface 3007 of the light grating 3001 having multiple focuses is a plane surface.
5. Referring to FIGS. 31 and 31A, in the drawings, a light grating 3101 having multiple focuses is composed of a convex lens 3102, a concave lens 3103 and a lens with a non-arciform surface 3104, and there are two surfaces 3105, 3106 which are vertical surfaces of the front and the rear sides respectively of the light grating 3101 which is strip like, cloud shaped or annular, and a bottom surface 3107 of the light grating 3101 having multiple focuses is a plane surface.
6. Referring to FIGS. 32 and 32A, in the drawings, a light grating 3201 having multiple focuses is composed of a convex lens 3203, a concave lens 3202 and two lenses each with a non-arciform surface 3204, 3205, and there are two surfaces 3206, 3207 which are vertical surfaces of the front and the rear sides respectively of the light grating 3201 which is strip like, cloud shaped or annular, and a bottom surface 3208 of the light grating 3201 having multiple focuses is a plane surface.

According to the above list many kinds of embodiments, the light distribution boards of the present invention can be used respectively for a light outputting surface of a conventional lamp in lieu of a conventional lamp shade, thus a lamp set with a light distribution board of the present invention can be formed.

In conclusion, by specifically designing on light gratings, the light distribution boards of the present invention can get the expected effects thereof.

Having thus described my invention, what I claim as new and desire to be secured by Letters Patent of the United States is:

1. A light distribution board having an improved light grating structure including a plurality of light gratings each with multiple focuses, said light distribution board is used on a light outputting surface of a lamp to control refraction angular directions of light beams of said lamp, so that said light beams irradiate a district to be illuminated to get an effect of uniformly distributing, said lamp includes an obscured lamp shade, at least a reflective surface and at least a light source; said light distribution board having a plurality of light gratings each with multiple focuses includes at least a transparent board formed on at least one side thereof a plurality of light gratings each having multiple focuses, said light distribution board is characterized in that:
each of said light gratings having multiple focuses is composed of two or more arciform (concave or convex) lenses and at least one lens with a non-arciform surface to form a light grating having at least two focuses, curvature and inclination angle of each of said arciform (concave or convex) lenses forming said light grating having multiple focuses are changed in pursuance of angles of refraction of incident light beams through surfaces of said (concave or convex) lenses.

2. The light distribution board having an improved light grating structure including a plurality of light gratings each with multiple focuses as in claim 1, wherein: said transparent board is provided on its top surface with a plurality of light gratings each having multiple focuses, said light gratings with multiple focuses are strip like light gratings; said top surface is a light receiving surface of said lamp, a bottom surface of said transparent board is a plane surface and is an illuminating surface of said lamp.

3. The light distribution board having an improved light grating structure including a plurality of light gratings each with multiple focuses as in claim 1, wherein: said transparent board is provided on its top surface with a plurality of light gratings each having multiple focuses, said light gratings with multiple focuses are annular light gratings; said top surface is a light receiving surface of said lamp, a bottom surface of said transparent board is a plane surface and is an illuminating surface of said lamp.

4. The light distribution board having an improved light grating structure including a plurality of light gratings each with multiple focuses as in claim 1, wherein: said transparent board is provided on its top surface with a plurality of light gratings each having multiple focuses, said light gratings with multiple focuses are cloud shaped light gratings; said top surface is a light receiving surface of said lamp, a bottom surface of said transparent board is a plane surface and is an illuminating surface of said lamp.

5. The light distribution board having an improved light grating structure including a plurality of light gratings each with multiple focuses as in claim 1, wherein: said transparent board is provided on its top surface with a plurality of light gratings each having multiple focuses, said light gratings with multiple focuses are non-concentric annular light gratings; said top surface is a light receiving surface of said lamp, a bottom surface of said transparent board is a plane surface and is an illuminating surface of said lamp.

6. The light distribution board having an improved light grating structure including a plurality of light gratings each with multiple focuses as in claim 1, wherein: said transparent board is provided on its top surface with a plurality of light gratings each having multiple focuses, said light gratings with multiple focuses are composed of a plurality of non-concentric annular light gratings and a plurality of partially annular light gratings; said top surface is a light receiving surface of said lamp, a bottom surface of said transparent board is a plane surface and is an illuminating surface of said lamp.

7. The light distribution board having an improved light grating structure including a plurality of light gratings each with multiple focuses as in claim 1, wherein: said transparent board is provided on its top surface with a plurality of light gratings each having multiple focuses, said light gratings with multiple focuses are composed of a plurality of non-concentric and partially annular light gratings; said top surface is a light receiving surface of said lamp, a bottom surface of said transparent board is a plane surface and is an illuminating surface of said lamp.

8. The light distribution board having an improved light grating structure including a plurality of light gratings each with multiple focuses as in claim 1, wherein: said transparent board is provided on its top surface with a plurality of light gratings each having multiple focuses, said light gratings with multiple focuses are strip like gratings; said top surface is a light receiving surface of said lamp, a bottom surface of said transparent board is formed thereon a plurality of normal convex lenses and is an illuminating surface of said lamp.

9. The light distribution board having an improved light grating structure including a plurality of light gratings each with multiple focuses as in claim 1, wherein: said transparent board is provided on its top surface with a plurality of light gratings each having multiple focuses, said light gratings with multiple focuses are annular light gratings; said top surface is a light receiving surface of said lamp, a bottom surface of said transparent board is formed thereon a plurality of normal convex lenses and is an illuminating surface of said lamp.

10. The light distribution board having an improved light grating structure including a plurality of light gratings each with multiple focuses as in claim 1, wherein: said transparent board is provided on its top surface with a plurality of light gratings each having multiple focuses, said light gratings with multiple focuses are annular light gratings arranged in steps; said top surface is a light receiving surface of said lamp, a bottom surface of said transparent board is a plane surface and is an illuminating surface of said lamp.

11. The light distribution board having an improved light grating structure including a plurality of light gratings each with multiple focuses as in claim 1, wherein: said transparent board is provided on its top surface with a plurality of light gratings each having multiple focuses, said light gratings with multiple focuses are annular light gratings arranged in steps; said top surface is a light receiving surface of said lamp, a bottom surface of said transparent board is an arciform surface and is an illuminating surface of said lamp.

12. The light distribution board having an improved light grating structure including a plurality of light gratings each with multiple focuses as in claim 1, wherein: said transparent board is provided on its top surface with a plurality of light gratings each having multiple focuses, said light gratings with multiple focuses are annular light gratings arranged in steps; said top surface is a light receiving surface of said lamp, a bottom surface of said transparent board is formed thereon a plurality of normal convex lenses and is an illuminating surface of said lamp.

13. The light distribution board having an improved light grating structure including a plurality of light gratings each with multiple focuses as in claim 1, wherein: said transparent board is provided on its top surface with a plurality of light gratings each having multiple focuses, said light gratings with multiple focuses are annular light gratings arranged in steps; said top surface is a light receiving surface of said lamp, a bottom surface of said transparent board is formed thereon a plurality of normal convex lenses arranged in annular shapes and is an illuminating surface of said lamp.

14. The light distribution board having an improved light grating structure including a plurality of light gratings each with multiple focuses as in claim 1, wherein: said transparent board is in a shape chosen from rectangular; circle, elliptical and strange shapes.

15. The light distribution board having an improved light grating structure including a plurality of light gratings each with multiple focuses as in claim 1, wherein: material for said transparent board is chosen from transparent plastics and transparent glass.

16. The light distribution board having an improved light grating structure including a plurality of light gratings each with multiple focuses as in claim 1, wherein: amount of said at least a transparent board is two which mutually overlap; and of which an upper transparent board is provided on its top surface with a plurality of light gratings each having multiple focuses, said top surface is a light receiving surface of said lamp, and a bottom surface of said upper transparent board is a plane surface; and of which a lower transparent board is provided on its top surface with a plurality of light gratings each having multiple focuses, said top surface is a light receiving surface of said lamp, and a bottom surface of said lower transparent board is a plane surface or is formed thereon a plurality of normal convex lenses and is an illuminating surface of said lamp.

17. The light distribution board having an improved light grating structure including a plurality of light gratings each with multiple focuses as in claim 1, wherein: said two or more arciform (concave or convex) lenses of each of said light gratings are convex lenses.

18. The light distribution board having an improved light grating structure including a plurality of light gratings each with multiple focuses as in claim 1, wherein: said two or more arciform (concave or convex) lenses of each of said light gratings are concave lenses.

19. The light distribution board having an improved light grating structure including a plurality of light gratings each with multiple focuses as in claim 1, wherein: said two or more arciform (concave or convex) lenses of each of said light gratings are partial convex lenses and partial concave lenses.
